(19) United States
(12) Patent Application Publication
(10) Pub. No.: US 2021/0356310 A1
(43) Pub. Date: Nov. 18, 2021

(54) PARTICULATE HEIGHT CALCULATIONS FROM PRESSURE GRADIENTS

(71) Applicant: HEWLETT-PACKARD DEVELOPMENT COMPANY, L.P., Spring, TX (US)

(72) Inventors: Luke P. Sosnowski, Vancouver, WA (US); Tait A. Regnier, Vancouver, WA (US); Philip J. Stallbaumer, Vancouver, WA (US); Terry Lambright, Corvallis, OR (US); Richard King, Corvallis, OR (US)

(21) Appl. No.: 16/607,491

(22) PCT Filed: Apr. 30, 2018
(86) PCT No.: PCT/US2018/030308

§ 371 Date: Oct. 23, 2019

(51) Int. Cl. G01F 23/16; B29C 64/393; B05B 12/08

(52) U.S. Cl. CPC G01F 23/167; B33Y 50/02; B05B 12/085; B29C 64/393

(57) ABSTRACT

According to examples, an apparatus may include a first pressure sensor to measure a first pressure level at a first height within a particulate material contained in a container and a second pressure sensor to measure a second pressure level at a second height within the container, in which a gas is to be supplied into the particulate material at a predefined velocity, wherein the first pressure sensor is to measure the first pressure level and the second pressure sensor is to measure the second pressure level while the gas is supplied into the particulate material at the predefined velocity. The apparatus may also include a controller that may determine a pressure gradient from the first pressure level and the second pressure level and calculate a height of the particulate material in the container from the determined pressure gradient.

### BACKGROUND

In three-dimensional (3D) printing, an additive printing process is often used to make three-dimensional solid parts from a digital model. 3D printing is often used in rapid product prototyping, mold generation, mold master generation, and manufacturing. Some 3D printing techniques are considered additive processes because they involve the application of successive layers of particulate material to an existing surface (template or previous layer). Additive processes often include solidification of the particulate material, which for some materials may be accomplished through use of heat and/or chemical binders.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that includes a controller that may calculate a height of particulate material in a container;

FIGS. 2A-2C, respectively, show block diagrams of an example apparatus that includes a controller that may calculate a height of particulate material in a container;

FIG. 3 shows a block diagram of another example apparatus that includes a controller that may calculate a height of particulate material in a container;

FIG. 4 shows a flow diagram of an example method for calculating a height of particulate material in a container; and

FIG. 5 shows a block diagram of an example 3D fabrication system in which the apparatuses depicted in FIGS. 1-3 may be implemented.

### DETAILED DESCRIPTION

In some 3D fabrication systems that form objects from particulate material, the particulate material may be moved from storage bins to other locations in the 3D fabrication systems via conduits. For instance, the particulate material may be moved from a storage bin to a print bed where the particulate material may be applied and fabricated into the objects. In some 3D fabrication systems, the particulate material is fluidized, e.g., caused to acquire characteristics of a fluid by passing a gas through the particulate material, while in the storage bin. The fluidized particulate material may be introduced into an airstream in a conduit that flows from the storage bin to the print bed. At the print bed, the particulate material may be separated from the airflow, for instance, through use of cyclone separators.

The amount, e.g., height, depth, mass (e.g., via density calculations) or the like, of particulate material in the storage bin may be maintained above a predefined level to ensure that adequate quantities of the particulate material are available to be supplied to the print bed during printing. For instance, additional particulate material may be supplied into the storage bin when the amount of particulate material falls below a particular level. In addition, the velocity at which gas may be supplied into the particulate material may be varied depending upon the amount (e.g., height) of particulate material contained in the storage bin, e.g., the velocity may be reduced or increased as the particulate material height is reduced.

Some 3D fabrication systems include load cells to weigh the storage bin and may estimate the amount of particulate material in the storage bin based on the measured weight. The use of load cells, however, may be onerous and time consuming as the load cells may need to be calibrated to ensure accurate measurements. In addition, to properly calibrate the load cells, the storage bin may need to be emptied of the particulate material, which may add to the time used to calibrate the load cells.

Disclosed herein are apparatuses and methods to calculate a height of particulate material in a container, e.g., a storage bin, without using a load cell. Instead, the apparatuses and methods disclosed herein may calculate the height of the particulate material in the container based on a pressure gradient determined from measured pressure levels in the container. Particularly, the apparatuses disclosed herein may include a controller that may compare pressure levels measured at different heights within the container, in which at least one of the pressure levels may be measured within the particulate material. In some examples, at least two pressure levels may be measured within the particulate material contained in the container.

The controller may determine a slope of the measured pressure levels with respect to the heights at which the pressure levels were measured. In addition, the controller may determine the height of the particulate material based on an intersection between the line, e.g., a linear pressure gradient, formed between the measured pressure levels and a height corresponding to a reference pressure level. The reference pressure level may correspond to a pressure level measured by a third pressure sensor at a location above the particulate material in the container. In instances in which the particulate material drops below the height at which a second pressure level is measured, the controller may use a previously determined slope to calculate the height of the particulate material. In addition, the controller may access pressure levels measured by additional pressure sensors to determine whether the particulate material includes segregated particles.

Through implementation of the apparatuses and methods disclosed herein, the height of the particulate material in a container, and thus the amount of particulate material in the container, may be determined without measuring a weight of the container and the particulate material. In addition, the height of the particulate material in the container may be determined using measured pressures, which may be immune to vibrations and may not require that the particulate material be completely removed from the container for calibration of pressure sensors. Instead, the pressure sensors disclosed herein may be calibrated, e.g., zeroed, by stopping the gas flow through the particulate material for a sufficiently long period of time to enable the pressure within the particulate material to fully dissipate. In addition, particulate material properties, such as permeability, density/particle size, or the like, may be inferred from the measured pressures.

Before continuing, it is noted that as used herein, the terms “includes” and “including” mean, but is not limited to, “includes” or “including” and “includes at least” or “including at least.” The term “based on” means “based on” and “based at least in part on.”

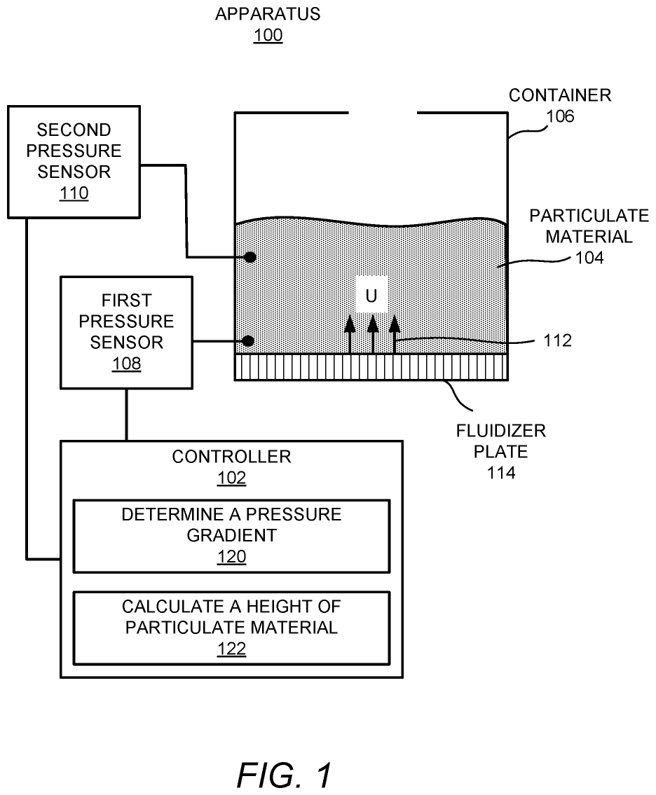

With reference first to FIG. 1, there is shown a block diagram of an example apparatus 100 that includes a controller 102 that may calculate a height of particulate material 104 in a container 106 (which may also be referenced as a bin, a storage bin, or the like, herein). It should be understood that the apparatus 100 depicted in FIG. 1 may include additional components and that some of the components described herein may be removed and/or modified without departing from a scope of the apparatus 100 disclosed herein.

As shown in FIG. 1, the apparatus 100 may also include a first pressure sensor 108 to measure a first pressure level at a first height within the particulate material 104 contained in the container 106. The first pressure sensor 108 may measure the first pressure level at a sufficiently low height within the particulate material 104 to ensure that the first pressure level may be measured within the particulate material 104 even in instances in which the particulate material 104 is below a minimum predefined level at which the supply of particulate material 104 is to be replenished.

The apparatus 100 may further include a second pressure sensor 110 to measure a second pressure level at a second height within the container 106. The second pressure sensor 110 may measure a pressure level within the particulate material 104 in the container 106. In addition or in other examples, the second pressure sensor 110 may measure a pressure level outside of the particulate material 104 within the container 106. For instance, the second pressure sensor 110 may measure a pressure level above the particulate material 104 within the container 106. In any regard, the first pressure sensor 108 and the second pressure sensor 110 may be any suitable type of air or gas pressure sensor and may be sensors that may generate a signal as a function of the pressure imposed on the pressure sensors 108 and 110. In any regard, the first pressure sensor 108 may measure the first pressure level and the second pressure sensor 110 may measure the second pressure level as gas (denoted by the arrow 112) is supplied into the particulate material 104 at a predefined velocity (U) through a fluidizer plate 114.

According to examples, the first pressure sensor 108 may be attached to a first tube that extends into the container 106 and the second pressure sensor 110 may be attached to a second tube that extends into the container 106. In addition, a first filter may be positioned in the first tube and a second filter may be positioned in the second tube. The first filter and the second filter may block or prevent the passage of particulate material 104 through the first tube and the second tube respectively to prevent the particulate material 104 from affecting pressure measurements obtained by the first pressure sensor 108 and the second pressure sensor 110. In addition, or in other examples, the pressure sensors 108, 110 may be attached at various heights to a circuit board that may be immersed into the particulate material contained in the container 106. The circuit may also include the controller 102 or the circuit may communicate with an externally located controller 102.

The first pressure sensor 108 and the second pressure sensor 110 may respectively communicate the first pressure level and the second pressure level to the controller 102. In addition, the controller 102 may determine 120 a pressure gradient from the first pressure level and the second pressure level. That is, for instance, the controller 102 may determine a difference between the first pressure level and the second pressure level.

The controller 102 may calculate 122 a height of the particulate material 104 in the container 106. The controller 102 may be a semiconductor-based microprocessor, a central processing unit (CPU), an application specific integrated circuit (ASIC), a field-programmable gate array (FPGA), a graphics processing unit (GPU), a tensor processing unit (TPU), and/or other hardware device. The apparatus 100 may also include a memory (not shown) that may have stored thereon machine readable instructions (which may also be termed computer readable instructions) that the controller 102 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer readable storage medium, may be a non-transitory machine-readable storage medium, where the term “non-transitory” does not encompass transitory propagating signals.

Various manners in which the controller 102 may calculate 122 the height of the particulate material 104 in the container 106 are discussed in greater detail herein below with respect to the following figures.

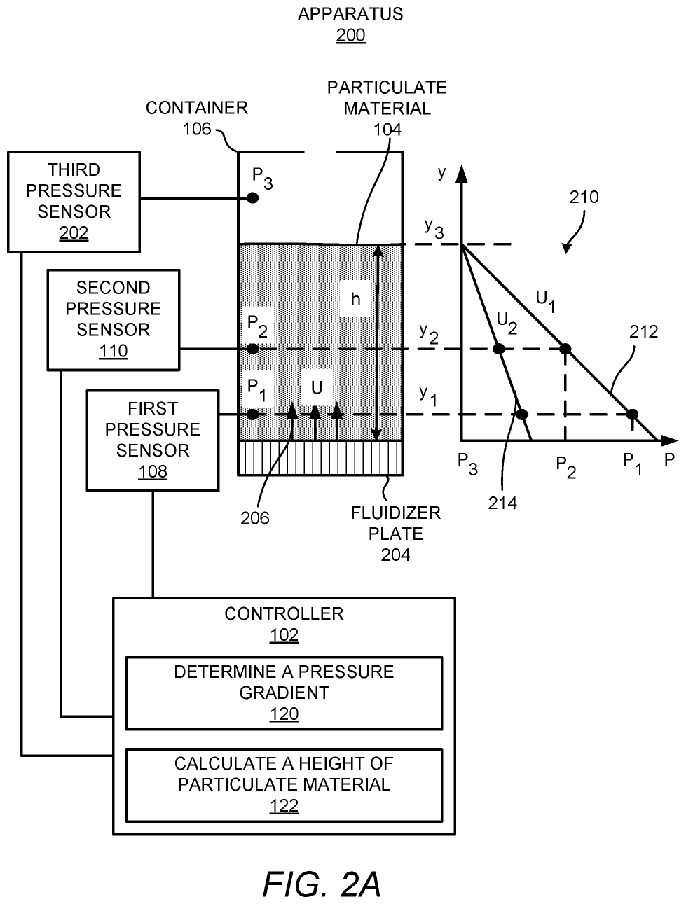

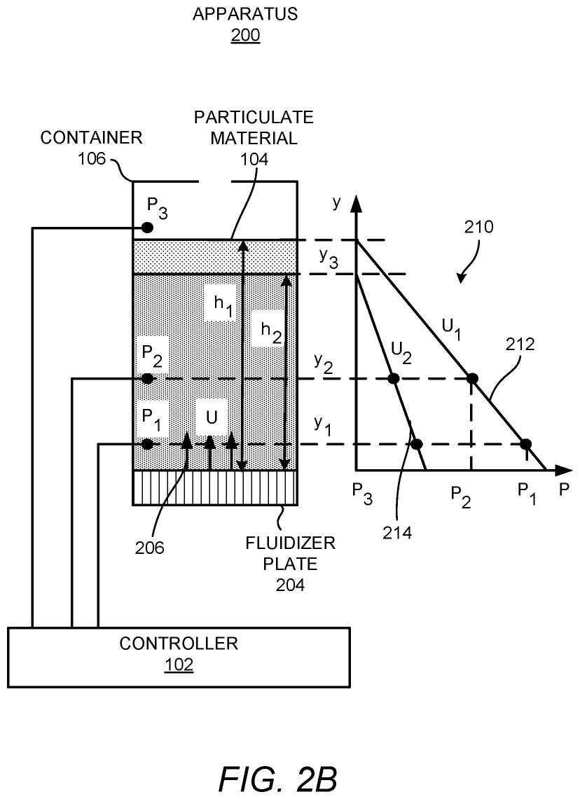

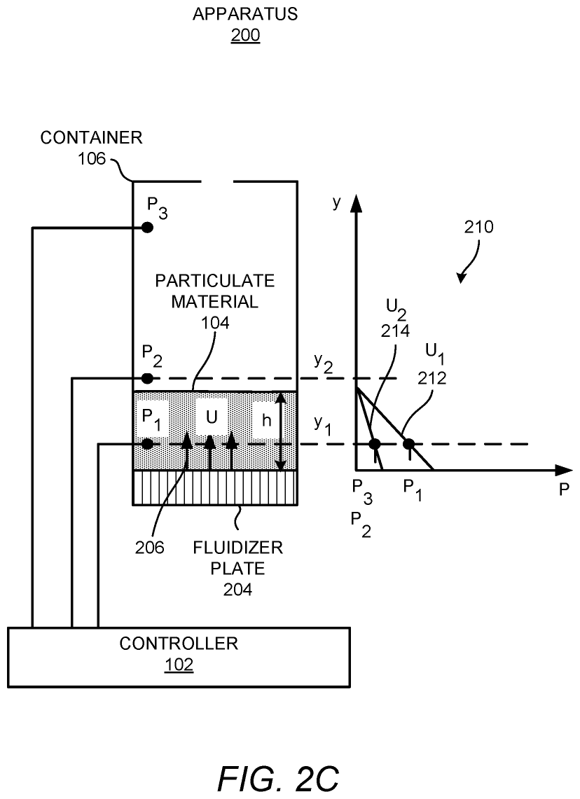

Turning now to FIGS. 2A-2C, there are respectively shown block diagrams of another example apparatus 200 that includes a controller 102 that may calculate a height of particulate material 104 in a container 106. It should be understood that the apparatus 200 depicted in FIGS. 2A-2C may include additional components and that some of the components described herein may be removed and/or modified without departing from a scope of the apparatus 200 disclosed herein.

As shown, the apparatus 200 may include the same features as the apparatus 100 depicted in FIG. 1. As such, the common features are not described in detail with respect to FIGS. 2A-2C. Instead, the features that differ from those depicted in FIG. 1 are described in detail. That is, in addition to the first pressure sensor 108 and the second pressure sensor 110, the apparatus 200 may include a third pressure sensor 202. The third pressure sensor 202 may measure a pressure level at a location inside the container 106 that is above the height of the particulate material 104. In this regard, the third pressure sensor 202 may measure air (or other gas) pressure level inside the container 106, e.g., a reference pressure level.

As also shown, a fluidizer plate 204 may be positioned at a base of the container 106. The fluidizer plate 204 may include a porous membrane through which pressurized gas may flow as indicated by the arrows 206. In addition, the gas may permeate into the particulate material 104 that is supported on the fluidizer plate 204. In examples, a gas pressure generator (not shown) may supply the gas through the fluidizer plate 204 with sufficient pressurization to cause the gas to flow through the fluidizer plate 204 with sufficient velocity and pressure to fluidize the particulate material 104. That is, the gas may be supplied at sufficient velocities through the particulate material 104 to cause the particulate material 104 to acquire characteristics of a fluid, which may mix the particulate material 104 and may facilitate movement of the particulate material 104. Generally speaking, fluidization of the particulate material 104 may help with the outflow of the particulate material 104 from the container 106 by enabling the particulate material 104 to flow better and to self-level. In addition, fluidization of the particulate material 104 may minimize the volume of stranded particulate material 104 in the container 106, which may facilitate emptying of the container 106. In other examples, the gas may be supplied at velocities below the velocities that cause the particulate material 104 to be fluidized. In addition, the controller 102 may calculate the height of the particulate material 104 while the gas is supplied at velocities above or below a fluidization velocity.

According to examples, the particulate material 104 may be build material particles used to form 3D objects through a 3D fabrication operation. For instance, the particulate material 104 may be formed of any suitable material including, but not limited to, polymers, plastics, metals, ceramics, combinations thereof, or the like, and may be in the form of a powder or a powder-like material. Additionally, the particulate material 104 may be formed to have dimensions, e.g., widths, diameters, or the like, that are generally between about 5 μm and about 100 μm. In other examples, the particulate material 104 may have dimensions that are generally between about 30 μm and about 60 μm. The particulate material 104 may have any of multiple shapes, for instance, as a result of larger particles being ground into smaller particles. In addition, the particulate material 104 may be fresh powder (e.g., unused build material particles), used powder (e.g., recycled build material particles), or a combination of fresh and used powder. In some examples, the powder may be formed from, or may include, short fibers that may, for example, have been cut into short lengths from long strands or threads of material.

The fluidizer plate 204 may extend across opposite side walls of the container 106 to prevent the particulate material 104 from falling between the fluidizer plate 204 and the sidewalls. In addition, the fluidizer plate 204 may be formed of a material and may have a suitable thickness to support the particulate material 104. For instance, the fluidizer plate 204 may be formed of polyethylene, metal, ceramic, plastic, combinations thereof, or the like. By way of particular example, the fluidizer plate 204 is formed of ultra high molecular weight polyethylene (UHMWPE). The fluidizer plate 204 may have a plurality of pores (which may equivalently termed channels), that enable the gas to flow the fluidizer plate 204 while preventing or minimizing blockage of the pores by the particulate material 104. The fluidizer plate 204 may include a drain opening, e.g., in a cutout portion of the fluidizer plate 204, through which the particulate material 104 may flow out of the container 106. Although not shown, a controllable feeder may be provided at the drain opening to control the expulsion of the particulate material 104 from the container 106.

Further shown in FIGS. 2A-2C is a graph 210 that graphically depicts correlations between measured pressures and heights. In other words, the graph 210 graphically depicts calculations that the controller 102 may perform to calculate the height of the particulate material 104 in the container 106. The vertical axis of the graph 210 may represent the height (or equivalently, depth) of the particulate material 104 as well as heights at which pressure levels are measured and the horizontal axis of the graph 210 may represent the pressure levels respectively measured by the first pressure sensor 108 (P₁), the second pressure sensor 110 (P₂), and the third pressure sensor 202 (P₃). As shown, the first pressure level (P₁) may be plotted at a first height (y₁) and the second pressure level (P₂) may be plotted at a second height (y₂). In addition, the pressure levels may be determined while the gas is supplied into the particulate material 104 at a predefined velocity (U) through the fluidizer plate 204.

As also shown, a first linear pressure gradient 212 corresponding to a first superficial gas velocity (U₁) may be plotted between the first pressure level (P₁) and the second pressure level (P₂). In addition, the height (h) of the particulate material 104 may correspond to a measured height (y₃) along the vertical axis, at the third pressure level (P₃). Thus, for instance, the measured height (y₃) of the particulate material 104 may differ for different third pressure levels (P₃). Further shown in FIG. 2A is a second linear pressure gradient 214 corresponding to a second superficial gas velocity (U₂) that may be lower than the first superficial gas velocity (U₁). As shown, both the first linear pressure gradient 212 and the second linear pressure gradient 214 may result in approximately the same measure height (y₃).

However, as shown in FIG. 2B, in some examples, the height (h₁) of the particulate material 104 corresponding to the first gas velocity (U₁) may be higher than the height (h₂) of the particulate material 104 corresponding to the second gas velocity (U₂). That is, as the gas velocity increases, the particulate material 104 may expand. In addition, as the pressure gradient 214 may remain linear, the calculated height may be an expanded height. Thus, for instance, the controller 102 may calculate 122 a different particulate material 104 height for different gas velocities.

As shown in FIG. 2C, there may be instances in which the height of the particulate material 104 may drop below the second height (y₂), e.g., the height at which the second pressure sensor 110 measures the pressure in the container 106. In these instances, as the second pressure sensor 110 and the third pressure sensor 202 may both be in the ambient air, the second pressure (p₂) may be equal to the third pressure (p₃), with some safety margin for sensor error and jitter (e.g., which a predefined deviation). In this regard, the graph 210 may not include a separate second pressure level measurement and thus, a linear equation may no longer be valid for determining the height of the particulate material 104. In these instances, the controller 102 may use a previously determined value for the line slope (C′) as a function of the gas velocity (U), for instance, as determined when the second pressure sensor 110 measured the second pressure level inside the particulate material 104. In this regard, the controller 102 may use the slope of the first linear pressure gradient 212 in instances in which gas is delivered at the first velocity (U₁) and may use the slope of the second linear pressure gradient 214 in instances in which gas is delivered at the second velocity (U₂).

According to examples, the controller 102 may determine whether the particulate material 104 includes segregated particulate materials, e.g., particulate materials having different densities. Particularly, the controller 102 may determine that particulate material 104 includes segregated particulate materials based on a determination that the slopes of the gradients between respective pairs of pressure levels differ from each other.

According to examples, the controller 102 may calculate the height (depth) of the particulate material 104 through calculation of the following equations.

Equation (1): p′₁=p₁−p₃, in which the height (h) may be calculated by:

$$h = {y}_{1} - \frac{{p}_{1}^{′} ( {y}_{2} - {y}_{1} )}{( {p}_{2} - {p}_{1} )} . \qquad Equation ( 2 )$$

Alternatively, Equations (1) and (2) may be written as:

$$C = \frac{( {y}_{2} - {y}_{1} )}{( {p}_{2} - {p}_{1} )} and \qquad Equation ( 3 )$$

Equation (4): h=y₁−Cp′₁, in which C is a slope of the line representing a linear pressure gradient.

According to examples, the controller 102 may control the flow rate at which the gas is supplied through the fluidizer plate 204 based on a calculated height of the particulate material 104. The controller 102 may also control the flow rate based on other features, such as, the type of particulate material 104 housed in the container 106, a density of the particulate material 104 housed in the container, or the like. In addition or alternatively, the controller 102 may control the supply of additional particulate material 104 into the container 106 based on a determination that the height of the particular material 104 has fallen below a predefined level.

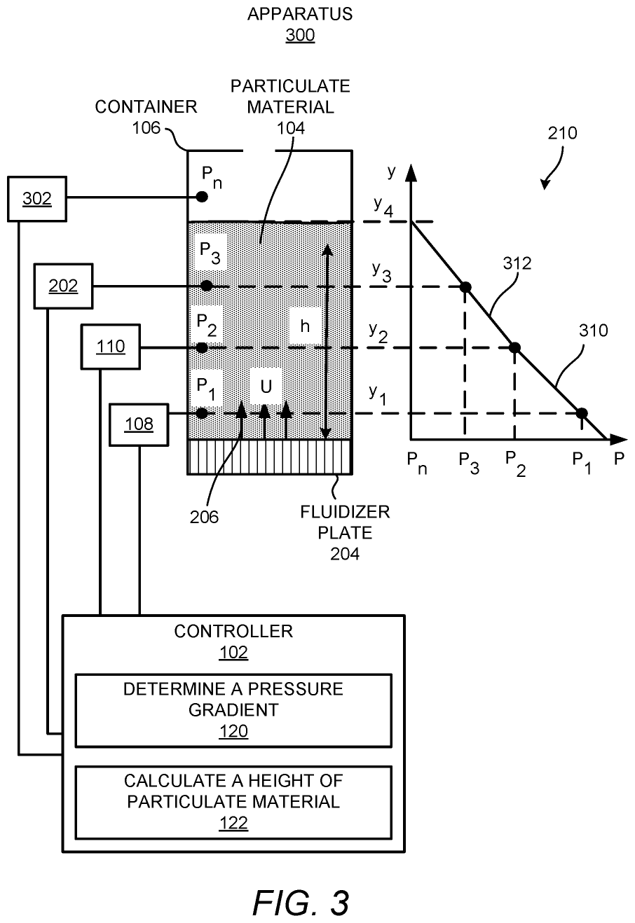

Turning now to FIG. 3, there is shown a block diagram of another example apparatus 300 that includes a controller 102 that may calculate a height of particulate material 104 in a container 106. It should be understood that the apparatus 300 depicted in FIG. 3 may include additional components and that some of the components described herein may be removed and/or modified without departing from a scope of the apparatus 300 disclosed herein.

As shown, the apparatus 300 may include the same features as the apparatuses 100, 200 depicted in FIGS. 1 and 2A-2C. As such, the common features are not described in detail with respect to FIG. 3. Instead, the features that differ from those depicted in FIGS. 1 and 2A-2C are described in detail. That is, in addition to the first pressure sensor 108, the second pressure sensor 110, the third pressure sensor 202, the apparatus 300 may also include a fourth pressure sensor 302 to measure a pressure level in ambient gas (or air) above the particulate material 104. In addition, the third pressure sensor 202 may be positioned to measure a pressure level within the particular material 104. Although four pressure sensors have been depicted in FIG. 3, it should be understood that the apparatus 300 may include any number of pressure sensors without departing from the scope of the apparatus 300.

As shown, the linear pressure gradient 310 between the first pressure level (P₁) and the second pressure level (P₂) may have a first slope and the linear pressure gradient 312 between the second pressure level (P₂) and the third pressure level (P₃) may have a second slope. This type of difference in slopes may occur in instances in which the particulate material 104 has non-uniform densities. For instance, particulate material 104 having greater density may fall to the bottom of the container 106 while particulate material 104 having less density may rise.

In the example shown in FIG. 3, the height of the particulate material 104 may be calculated through use of the pressure levels measured by the top two pressure sensors within the particulate material 104. That is, the controller 102 may solve for the equations discussed above using those pressure measurements and may disregard the pressure level(s) detected by pressure sensor(s) located below the top two pressure sensors.

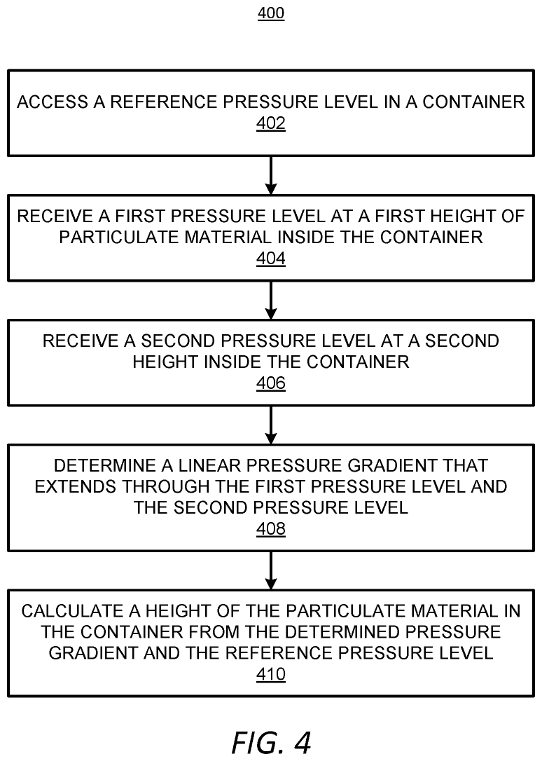

Various manners in which the controller 102 may operate are discussed in greater detail with respect to the method 400 depicted in FIG. 4. Particularly, FIG. 4 depicts a flow diagram of an example method 400 for calculating a height of particulate material 104 in a container 106). It should be understood that the method 400 depicted in FIG. 4 may include additional operations and that some of the operations described therein may be removed and/or modified without departing from the scopes of the method 400. The description of the method 400 is made with reference to the features depicted in FIGS. 1-3 for purposes of illustration.

At block 402, the controller 102 may access a reference pressure level in the container 106. The reference pressure level may correspond to a pressure level in the ambient gas above the particulate material 104 in the container 106. The reference pressure level may be measured by the third pressure level sensor 202 or another pressure sensor. In addition, or alternatively, the reference pressure level may be based on previously measured pressure levels.

At block 404, the controller 102 may receive a first pressure level (P₁) at a first height (y₁) of particulate material 104 inside the container 106. For instance, the first pressure sensor 108 may measure the first pressure level (P₁) within the particulate material 104 and may communicate the measured first pressure level (P₁) to the controller 102. In addition, the controller 102 may have previously been programmed with the first height (y₁).

At block 404, the controller 102 may receive a second pressure level (P₂) at a second height (y₂) inside the container (106). For instance, the second pressure sensor 110 may measure the second pressure level (P₂) within the particulate material 104 and may communicate the measured second pressure level (P₂) to the controller 102. In addition, the controller 102 may have previously been programmed with the second height (y₂). In addition, the first pressure level (P₁) and the second pressure level (P₂) may be measured as gas is supplied into the particulate material 104 through the fluidizer plate 204 at a velocity (U).

At block 406, the controller 102 may determine a linear pressure gradient 212 that extends through the first pressure level (P₁) and the second pressure level (P₂) in a graph 210 of pressures and heights.

At block 406, the controller 102 may calculate a height (y₃) of the particulate material 104 in the container 106 from the determined pressure gradient and the reference pressure level (P₃). For instance, the controller 102 may calculate the height (y₃) to be an identified point along a line that represents height corresponding to the reference pressure level (P₃), the identified point intersecting the linear pressure gradient 212. In addition, or alternatively, the controller 102 may calculate the height of the particulate material 104 in the container 106 through computation of any of Equations (1)-(4) discussed above.

Following the calculation of the height (y₃) of the particulate material 104 in the container 106, the controller 102 may compare the calculated height (y₃) with a predefined height. Based on a determination that the calculated height (y₃) is below the predefined height, the controller 102 may vary the velocity at which gas is supplied into the particulate material 104 through the fluidizer plate 204. In addition or alternatively, the controller 102 may cause additional particulate material 104 to be supplied into the container 106 such that the height of the particulate material 104 exceeds the predefined height.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

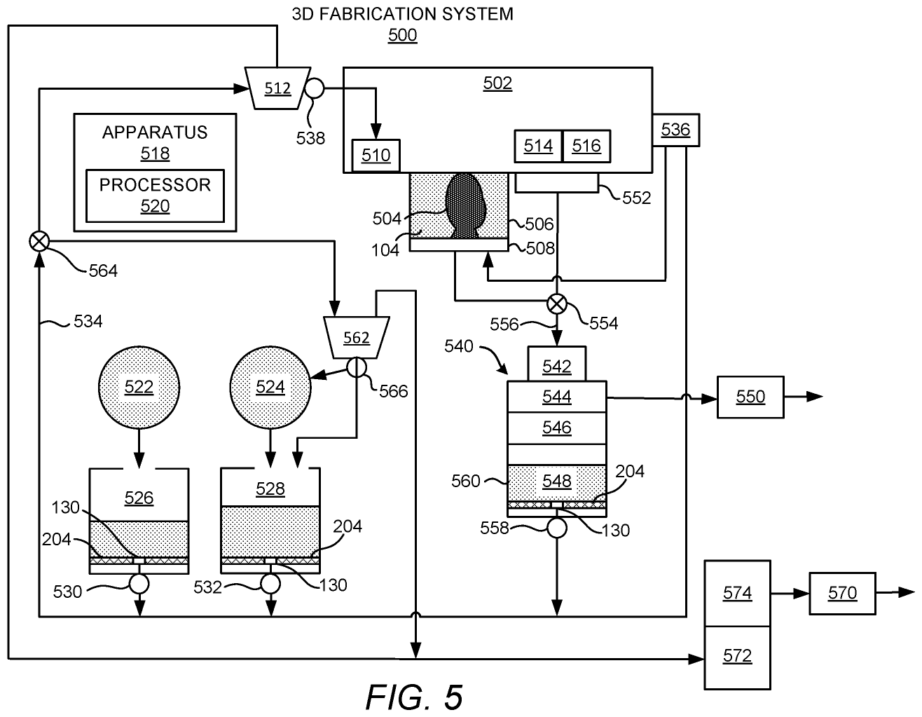

With reference now to FIG. 5, there is shown a block diagram of an example 3D fabrication system 500 in which the apparatuses 100-300 depicted in FIGS. 1-3 disclosed herein may be implemented. It should be understood that the 3D fabrication system 500 depicted in FIG. 5 may include additional components and that some of the components described herein may be removed and/or modified without departing from a scope of the 3D fabrication system 500 disclosed herein. The description of FIG. 5 is made with reference to the elements shown in FIGS. 1-4 for purposes of illustration and not of limitation.

As shown, the 3D fabrication system 500 may include a build chamber 502 within which a 3D object 504 may be fabricated from particulate material 104, e.g., build material particles, provided in respective layers in a build bucket 506. Particularly, a movable build platform 508 may be provided in the build bucket 506 and may be moved downward as the 3D object 504 is formed in successive layers of the particulate material 104. An upper hopper 512, which may include a cyclone separator, may supply a spreader 510 with the particulate material 104. The spreader 510 may move across the build bucket 506 to form the successive layers of the particulate material 104 received from the upper hopper 512.

Forming components 514 may be implemented to deliver an agent onto selected locations on the layers of particulate material 104 to form sections of the 3D object 504 in the successive layers. The forming components 514 may include an agent delivery device or multiple agent delivery devices, e.g., printheads, fluid delivery devices, etc. Thus, although the forming components 514 have been depicted as a single element, it should be understood that the forming components 514 may represent multiple elements. A heating mechanism 516 to apply heat onto the layers of particulate material 104 to form the sections of the 3D object 504 may also be provided in the build chamber 502.

According to examples, the agent may be a fusing agent that may enhance absorption of heat from the heating mechanism 516 to heat the particulate material 104 to a temperature that is sufficient to cause the particulate material 104 upon which the agent has been deposited to melt. In addition, the heating mechanism 516 may apply heat, e.g., in the form of heat and/or light, at a level that causes the particulate material 104 upon which the agent has been applied to melt without causing the particulate material 104 upon which the agent has not been applied to melt. In other examples, the agent may be a chemical binder that may cause the particulate material 104 upon which the agent is deposited to bind together to form part of a 3D object when the agent solidifies. In these examples, the heating mechanism 516 may be implemented to dry the agent or may be omitted in instances in which the chemical binder binds the particulate material 104 in the absence of additional heat.

According to examples, a suitable fusing agent may be an ink-type formulation comprising carbon black, such as, for example, the fusing agent formulation commercially known as V1Q60Q “HP fusing agent” available from HP Inc. In one example, such a fusing agent may additionally include an infra-red light absorber. In one example, such an ink may additionally include a near infra-red light absorber. In one example, such a fusing agent may additionally include a visible light absorber. In one example, such an ink may additionally include a UV light absorber. Examples of inks including visible light enhancers are dye-based colored ink and pigment based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

The forming components 514 may supply multiple types of agents onto the layers of particulate material 104. The multiple types of agents may include agents having different properties with respect to each other. In this regard, a processor 520 of a computing apparatus 518 may control the forming components 514 to supply the agent or a combination of agents that results in the object 504 having certain features. By way of particular example, the multiple types of agents may be differently colored inks and the processor 520 may control the forming components 514 to deposit an agent or a combination of agents onto particulate material 104 to form an object 504 having a particular color from the particulate material 104.

The processor 520 may control various operations in the 3D fabrication system 500 including the spreader 510, the hopper 512, and the forming components 514. The processor 520 may implement operations to control the forming components 514 to form the 3D object 504 in a volume of particulate material 104 contained in the build bucket 506. In examples, the processor 520 may be equivalent to the controller 102.

The particulate material 104 used to form the 3D object 504 may be composed of particulate material from a fresh supply 522 of build material particles, build material particles from a recycled supply 524 of build material particles, or a mixture thereof. The fresh supply 522 may represent a removable container that contains particulate material 104 that has not undergone any 3D object formation cycles. The recycled supply 524 may represent a removable container that contains particulate material 104 that has undergone at least one 3D object formation cycle and may contain particles that have undergone different numbers of 3D object formation cycles with respect to each other.

As shown, the particulate material 104 in the fresh supply 522 may be provided into a fresh material hopper 526 and the particulate material 104 in the recycled supply 524 may be provided into a recycled material hopper 528. Additionally, the particulate material 104 in either or both of the fresh material hopper 526 and the recycled material hopper 528 may be supplied to the upper hopper 512. The particulate material 104 may be provided into the hoppers 526, 528 from the respective supplies 522, 524 prior to implementing a print job to ensure that there are sufficient particulate materials 104 to complete the print job. Either or both of the hoppers 526, 528 may be equivalent to the apparatuses 100, 200, 300 discussed herein. Thus, for instance, the hoppers 526 and/or 528 may include a fluidizing assembly, e.g., a container 106 having a fluidizer plate 204, to fluidize particulate material 104 contained in the hoppers 526 and/or 528. Openings 130 may be included in the fluidizer plates 204 through which the fluidized particulate material 104 may be expelled from the hoppers 526 and/or 528.

Generally speaking, the processor 520 may control the mixture or ratio of the fresh particles and recycled particles that are supplied to the upper hopper 512. The ratio may depend upon the type of 3D object 504 being formed. For instance, a higher fresh particle to recycled particle ratio, e.g., up to a 100 percent fresh particle composition, may be supplied when the 3D object 504 is to have a higher quality, to have thinner sections, have higher tolerance requirements, or the like. Conversely, a lower fresh particle to recycled particle ratio, e.g., up to a 100 percent recycled particle composition, may be supplied when the 3D object 504 is to have a lower quality as may occur when the 3D object 504 is a test piece or a non-production piece, when the 3D object 504 is to have lower tolerance requirements, or the like. The ratio may be user-defined, may be based upon a particular print job, may be based upon a print setting of the 3D fabrication system 500, and/or the like.

In any regard, the processor 520 may control the ratio of the fresh and the recycled particles supplied to the upper hopper 512 through control of respective feeders 530, 532. A first feeder 530 may be positioned to supply particulate material 104 to a supply line 534 from the fresh material hopper 526 and the second feeder 532 may be positioned to supply particulate material 104 to the supply line 534 from the recycled material hopper 528. The first feeder 530 and the second feeder 532 may be rotary airlocks that may regulate the flow of the particulate material 104 from the respective hoppers 526, 528 to the feed line 534 for delivery to the upper hopper 512. The feed line 534 may also be supplied with air from an input device 536 to assist in the flow of the particulate materials 104 from the hoppers 526, 528 to the upper hopper 512.

A third feeder 538, which may also be a rotary airlock (which allows forward-flow of powder and restricts back-flow of air), may be positioned along a supply line from the upper hopper 512 to the spreader 510. The upper hopper 512 may include a level sensor (not shown) that may detect the level of particulate material 104 contained in the upper hopper 512. The processor 520 may determine the level of the particulate material 104 contained in the upper hopper 512 from the detected level and may control the feeders 530, 532 to supply additional particulate material 104 in a particular ratio when the processor 520 determines that the particulate material 104 level in the upper hopper 512 is below a threshold level, e.g., to ensure that there is a sufficient amount of particulate material 104 to form a layer of particulate material 104 having a certain thickness during a next spreader 510 pass.

The 3D fabrication system 500 may also include a collection mechanism 540, which may include a blow box 542, a filter 544, a sieve 546, and a reclaimed material hopper 548. The reclaimed material hopper 548 may be equivalent to the apparatuses 100 discussed herein. Thus, for instance, the reclaimed hopper 548 may include a fluidizing assembly to fluidize particulate material 104, e.g., a fluidizer plate 204 having a drain opening 130, contained in the reclaimed hopper 548. Airflow through the collection mechanism 540 may be provided by a collection blower 550. The collection mechanism 540 may reclaim incidental particulate material 104 from the build bucket 506 as well as from a location adjacent to the build bucket 506 as shown in FIG. 5. Particularly, following formation of the 3D object 504, the particulate material 104 may remain in powder form and the collection mechanism 540 may reclaim the particulate material 104 that was not formed into the 3D object 504. That is, the incidental particulate material 104 may be separated from the 3D object 504 through application of a vacuum force inside the build bucket 506. The collection mechanism 540 may also be vibrated to separate the incidental particulate material 104 from the 3D object 504.

The incidental particulate material 104 in the build bucket 506 may be sucked into the blow box 542 and through the filter 544 and the sieve 546 before being collected in the reclaimed material hopper 548. Additionally, during spreading of the particulate material 104 to form layers on the build bucket 506, e.g., as the spreader 510 moves across the build bucket 506, excess particulate material 104 may collect around a perimeter of the build bucket 506. As shown, a perimeter vacuum 552 may be provided to collect the excess particulate material 104, such that the collected particulate material 104 may be supplied to the collection mechanism 540. A valve 554, such as an electronically controllable three-way valve, may be provided along a feed line 556 from the build bucket 506 and the perimeter vacuum 552. In examples, the processor 520 may manipulate the valve 554 such that particles flow from the perimeter vacuum 552 during formation of the 3D object 504 and flow from the build bucket 506 following formation of the 3D object 504.

A fourth feeder 558, which may also be a rotary airlock, may be provided to feed the reclaimed particulate material 560 contained in the reclaimed material hopper 548 to the upper hopper 512 and/or to a lower hopper 562. The fourth feeder 558 may feed the reclaimed particulate material 560 through the feed line 534. A valve 564, such as an electronic three-way valve, e.g., the valve 564 may be a three-port, two-state valve in which materials may flow in one of two directions), may be provided along the feed line 534 and may direct the reclaimed particulate material 560 to the upper hopper 512 or may divert the reclaimed particulate material 560 to the lower hopper 562. The processor 520 may also manipulate the valve 564 to control whether the reclaimed particulate material 560 are supplied to the upper hopper 512 or the lower hopper 562. As discussed above, the processor 520 may make this determination based upon the ratio of fresh and recycled particulate materials that is to be used to form the 3D object 504.

A fifth feeder 566, which may also be a rotary airlock, may be provided to feed the reclaimed particulate material 104 contained in the lower hopper 562 to the recycled supply 524 and/or the recycled material hopper 528. The processor 520 may control the fifth feeder 566 to feed the reclaimed particulate material 560 into the recycled supply 524 in instances in which the reclaimed particulate material 560 are not to be used in a current build. In addition, the processor 520 may control the fifth feeder 566 to feed the reclaimed particulate material 560 into the recycled material hopper 528 in instances in which the reclaimed particulate material 560 are to be used in a current or a next build.

The 3D fabrication system 500 may also include a blower 570 that may create suction to enhance airflow through the lines 534 in the 3D fabrication system 500. The airflow may flow to a filter box 572 and a filter 574 that may remove particulates from the airflow from the upper hopper 512 and the lower hopper 562 prior to the airflow being exhausted from the 3D fabrication system 500. In other words, the blower 570, filter box 572, and filter 574 may represent parts of the outlets of the upper hopper 512 and the lower hopper 562 and may collect particulates that were not removed from the airflow in cyclone separators connected to the upper and/or lower hoppers 512 and 562.

Although not shown in FIG. 5, the computing apparatus 518 may also include an interface through which the processor 520 may communicate instructions to a plurality of components contained in the 3D fabrication system 500. The interface may be any suitable hardware and/or software through which the processor 520 may communicate the instructions. In any regard, the processor 520 may communicate with the components of the 3D fabrication system 500 as discussed above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a first pressure sensor to measure a first pressure level at a first height within a particulate material contained in a container;
a second pressure sensor to measure a second pressure level at a second height within the container, wherein a gas is to be supplied into the particulate material at a predefined velocity, wherein the first pressure sensor is to measure the first pressure level and the second pressure sensor is to measure the second pressure level while the gas is supplied into the particulate material at the predefined velocity;
a controller to:
determine a pressure gradient from the first pressure level and the second pressure level; and
calculate a height of the particulate material in the container from the determined pressure gradient.

2. The apparatus of claim 1, wherein the second pressure sensor is to measure the second pressure level within the particulate material contained in the container.

3. The apparatus of claim 1, wherein the controller is further to:
access a reference pressure level above the particulate material; and
calculate the height of the particulate material in the container from a correlation between the determined pressure gradient and the accessed reference pressure level.

4. The apparatus of claim 3, further comprising:
a third pressure sensor to measure the reference pressure level inside the container.

5. The apparatus of claim 3, wherein the controller is to, based on a determination that the second pressure level is equivalent within a predefined deviation to the reference pressure level, access a previously determined pressure gradient that is based on the predefined velocity at which the gas is supplied and to calculate the height of the particulate material in the container from the previously determined pressure gradient, wherein the previously determined pressure gradient was determined while the particulate material was above the second level.

6. The apparatus of claim 3, wherein the controller is to calculate the height (h) of the particulate material in the container according to the following equation:
$$h = {y}_{1} - \frac{{p}_{1}^{′} ( {y}_{2} - {y}_{1} )}{( {p}_{2} - {p}_{1} )} ,$$
wherein y₁ is a height at which the first pressure sensor is to measure the first pressure level p₁, y₂ is a height at which the second pressure sensor is to measure the second pressure level p₂, and p′₁ is equal to a difference between the first pressure level p₁ and the reference pressure level.

7. The apparatus of claim 3, wherein the determined pressure gradient is a linear pressure gradient.

8. The apparatus of claim 1, wherein the first pressure sensor is attached to a first tube and the second pressure sensor is attached to a second tube, the apparatus further comprising:
a first filter positioned in the first tube; and
a second filter positioned in the second tube, the first filter and the second filter to filter out the particulate material from flowing through the first tube and the second tube, respectively.

9. A method comprising:
accessing, by a controller, a reference pressure level in a container;
receiving, by the controller, a first pressure level at a first height of particulate material inside the container;
receiving, by the controller, a second pressure level at a second height inside the container, the first pressure level and the second pressure level being measured as gas is supplied into the particulate material;
determining, by the controller, a linear pressure gradient that extends through the first pressure level and the second pressure level; and
calculating, by the controller, a height of the particulate material in the container from the determined pressure gradient and the reference pressure level.

10. The method of claim 9, wherein calculating the height further comprises calculating the height to be an identified point along a line that represents height corresponding to the reference pressure level, the identified point intersecting the linear pressure gradient.

11. The method according to claim 9, wherein receiving the first pressure level comprises receiving the first pressure level from a first pressure sensor, wherein receiving the second pressure level comprises receiving the second pressure level from a second pressure sensor, and wherein accessing the reference pressure level comprises receiving the reference pressure level from a third pressure sensor.

12. The method according to claim 11, wherein calculating the height (h) of the particulate material in the container further comprises calculating the height (h) according to the following equation:
$$h = {y}_{1} - \frac{{p}_{1}^{′} ( {y}_{2} - {y}_{1} )}{( {p}_{2} - {p}_{1} )} ,$$
wherein y₁ is a height at which the first pressure sensor is to measure the first pressure level p₁, y₂ is a height at which the second pressure sensor is to measure the second pressure level p₂, and p′₁ is equal to a difference between the first pressure level p₁ and the reference pressure level.

13. A system comprising:
a bin having a bed and a fluidizer plate on which particulate material is supported, wherein the particulate material is to be conditioned by a gas supplied through the fluidizer plate;
a first pressure sensor to measure a first pressure level at a first height within the particulate material as the particulate material is conditioned;
a second pressure sensor to measure a second pressure level at a second height as the particulate material is conditioned;
a controller to,
determine a linear pressure gradient from the first pressure level and the second pressure level; and
calculate a height of the particulate material in the bin from the determined linear pressure gradient.

14. The system of claim 13, wherein the controller is further to:
access a reference pressure level above the particulate material; and
calculate the height of the particulate material in the bin from a correlation between the determined pressure gradient and the accessed reference pressure level.

15. The system according to claim 13, further comprising:
a third pressure sensor to measure a third pressure level at a third height within the particulate material as the particulate material is conditioned, wherein the controller is further to:
determine a second linear pressure gradient that extends through the second pressure level and the third pressure level;
determine whether a slope of the second linear pressure gradient differs from a slope of the linear pressure gradient; and
based on the slope of the second linear pressure gradient differing from the slope of the linear pressure gradient, determine that the particulate materials include segregated particulate materials.
